(19) United States
(12) Patent Application Publication
(10) Pub. No.: US 2004/0213429 A1
(43) Pub. Date: Oct. 28, 2004

(54) Fixture mounting assembly

(76) Inventor: Gary Seidler, Scottsdale, AZ (US)

Correspondence Address: SANDRA L. ETHERTON, ETHERTON LAW GROUP, LLC, PO BOX 27843, TEMPE, AZ, 85285-7843, US

(21) Appl. No.: 10/422,421

(22) Filed: Apr. 23, 2003

(51) Int. Cl. H04R 1/02

(52) U.S. Cl. 381/386; 381/395

(57) ABSTRACT

An assembly for mounting recessed fixtures into a substrate, including an enclosure having a threaded sidewall and a matedly-threaded collar, such that the substrate is sandwiched between the enclosure and the collar.

### FIELD OF INVENTION

This invention relates generally to mounting assemblies for fixtures that are recessed into the ceiling or wall. This invention relates more particularly to an improved speaker enclosure that mounts directly to the substrate and obviates the need for additional framework.

### BACKGROUND

Traditionally a drop ceiling is created by suspending a steel grid from a roof, upper floor joists, or other sturdy upper structure and then laying ceiling tiles upon this grid so that they are supported by the grid. A cavity is thus formed between the ceiling and the upper structure. Duct work and wiring are often hidden in this cavity, as are fixtures such as lighting cans and speaker enclosures. These fixtures are typically installed by adding supplemental ribs or straps to the grid, creating a “H” structure within one square of a grid for each fixture, upon which the perimeter edge of the fixture is attached. The “H” grid thus supports the fixture. The prior art is replete with means for attaching the fixture to the additional support, such as spring-clamps, torsion springs, pins, and screws. The additional ribs and attachment means are time consuming to install and add expense to the installation. It would be desirable to have an easier and less expensive method of installing fixtures into the ceiling.

Therefore, it is an object of this invention to provide an assembly for easier installation of fixtures into a ceiling. It is a further object to provide a mounting assembly that can be installed directly to the ceiling tile, with no “H” grid or other supplementary support structure. It is another object to provide a mounting assembly that uses a simple means for attaching the assembly to the ceiling. It is also an objective to provide an assembly that can be installed in less time than the fixtures currently known in the prior art.

### SUMMARY OF THE INVENTION

The present invention is an assembly for mounting recessed fixtures such as speaker enclosures and lighting cans into a substrate such as a ceiling tile. The assembly includes an enclosure having a threaded sidewall and a matedly-threaded collar, such that the substrate is sandwiched between the enclosure and the collar. A speaker or light socket is then installed into the enclosure, followed with various trim features as desired.

### BRIEF DESCRIPTION OF THE DRAWINGS

FIG. 1 is an exploded view of the first embodiment of the present invention.

FIG. 2 is a cross-sectional view of the first embodiment of the present invention installed in a ceiling tile.

FIG. 3 is a cross-sectional view of the first embodiment of the present invention installed in a ceiling tile and employing a truncated enclosure that is open at both ends.

FIG. 4 is an exploded view of the second embodiment of the present invention.

FIG. 5 is a cross-sectional view of the second embodiment of the present invention installed in a ceiling tile.

FIG. 6 is a cross-sectional view of the second embodiment of the present invention installed in a ceiling tile and employing a truncated enclosure that is open at both ends.

### DETAILED DESCRIPTION OF THE INVENTION

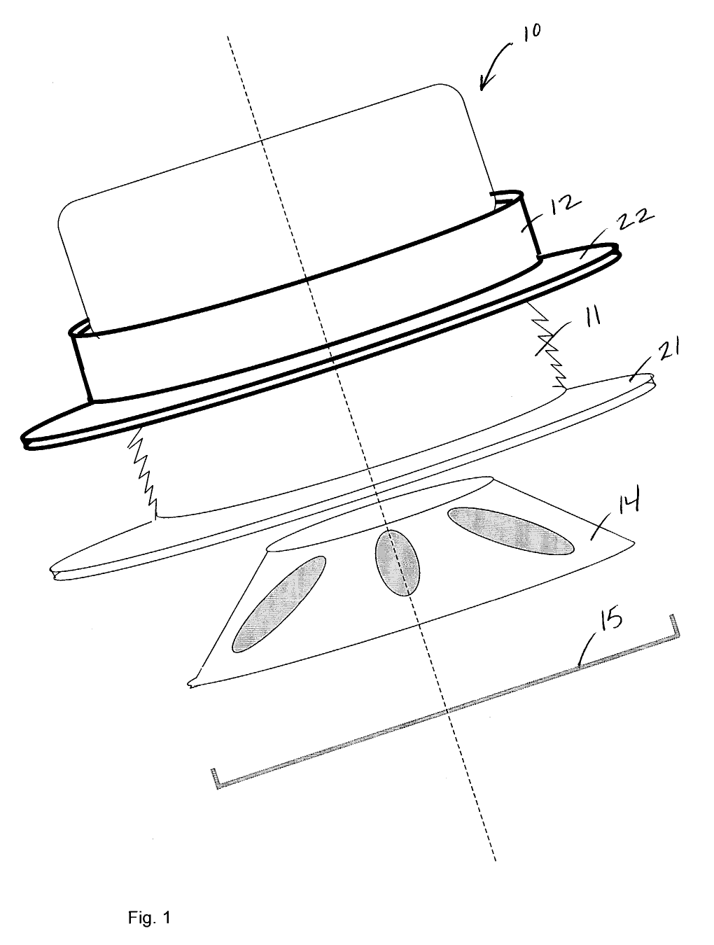

The first embodiment of the present invention is illustrated in FIGS. 1-3. The assembly is referred to generally as 10, and comprises an enclosure 11 and a collar 12. Both the enclosure 11 and the collar 12 have an annular flange that extends substantially perpendicularly from the sidewall of the enclosure. The flange on the enclosure is referred to herein as an enclosure bezel 21 and the flange on the collar is referred to as the collar bezel 22. The exterior sidewall of the enclosure 11 is threaded and the interior of the collar 12 is constructed with threads to match. FIG. 1 shows an exploded view of the assembly, including a speaker 14 and a speaker grille 15, aligned about the center axis.

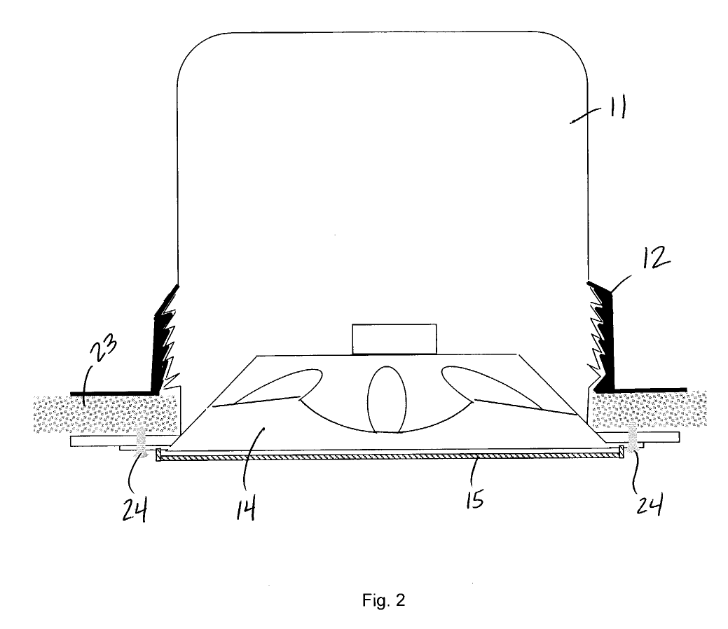

To install the assembly, one ceiling tile is removed from a drop ceiling. An aperture is cut into the ceiling tile in sufficient size and shape to accommodate the desired fixture. In the preferred embodiment, a speaker enclosure is used that is open on the bezel end and enclosed at the other end, with length between the bezel end and enclosed end to form a tubular cavity. The enclosure may also have apertures to allow wires from the fixture to pass into the ceiling cavity. The closed end of the speaker enclosure is inserted through the front (the side facing the room) of the ceiling tile 23 so that the enclosure bezel 21 touches the ceiling tile 23. A collar 12 is attached to the enclosure 11 from the back (the side facing the ceiling cavity) of the ceiling tile 23. The collar 12 is screwed onto the enclosure 11 until the ceiling tile 23 is securely sandwiched between the enclosure bezel 21 and the collar bezel 22. A speaker 14 is inserted into the enclosure from the front, so that the diaphragm of the speaker faces into the room. The speaker 14 is attached to the enclosure 11 with speaker screws 24 or other mounting means as are known in the art. Alternatively, the speaker 14 may be attached to the enclosure with a friction fit, such as snap-fit or with threads. A grille 15 is attached to the assembly over the speaker, preferably with a friction fit such as snap-fit or threads. FIG. 2 illustrates a cross section of the assembled preferred embodiment.

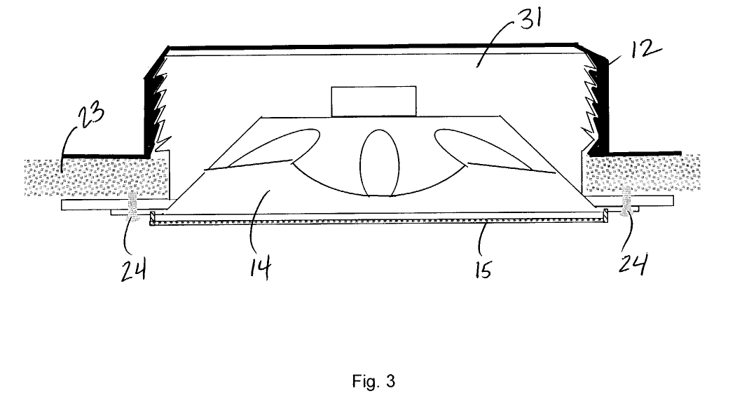

In some cases it may be desirable to use an enclosure that is open on both ends. FIG. 3 illustrates a truncated enclosure 31 that is cropped short and open at both ends, the bezel end and the end opposite of the bezel. Because the collar 12 is normally open at both ends, it will fit the truncated enclosure 31, as well as the standard enclosure 11. Eliminating the longer sidewalls of the enclosure reduces the weight of the assembly, which may be desired to permit the ceiling tile to support he assembly without additional support structure.

The bezels support the assembly on the substrate. The bezels will have different widths deepening on the weight to be supported, where the width of the bezel is the distance between its inside diameter and its outside diameter. The bezel width may be several times the height of the enclosure. Using a wider bezel allows the weight of the assembly to be distributed across more of the substrate. Wider bezels also help keep the ceiling tile from sagging due to the weight of the fixture. Preferably the assembly is made of a lightweight material so that the ceiling tile can support the assembly with no additional support structure, thereby eliminating the need for the “H” grid. It is also desirable that the assembly material be nonflammable and meet the required safety and electrical codes. Such materials include tin, steel, aluminum, and plastics and nylons having sufficiently high melting temperatures. In areas of high humidity, it may also be desirable to use material that is rust resistant and water resistant.

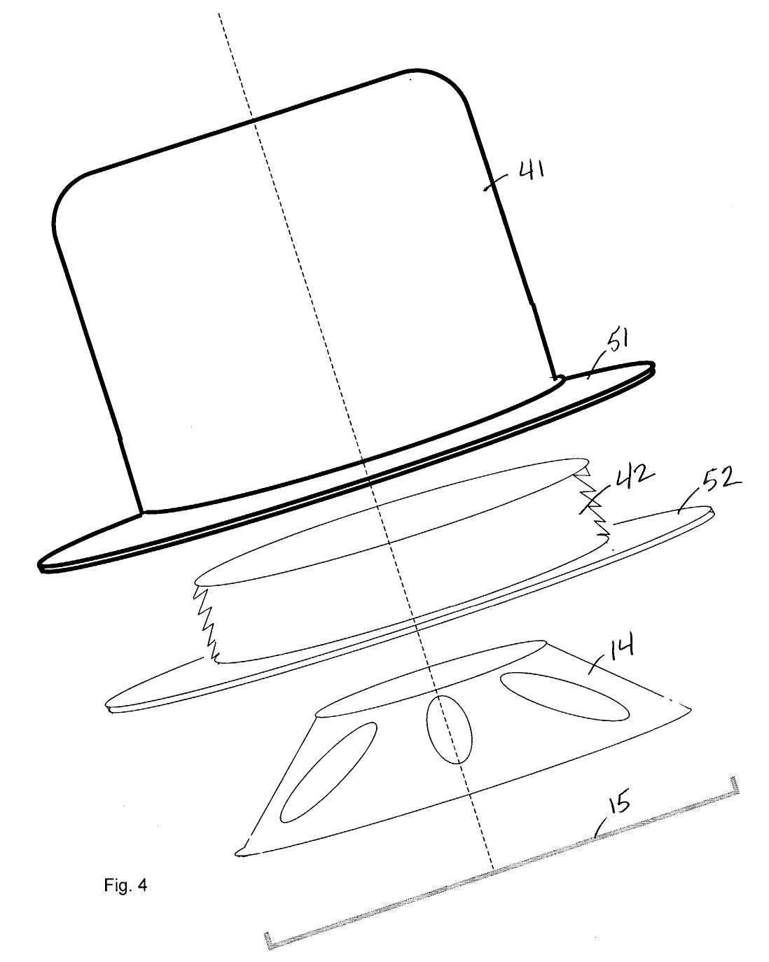

A second embodiment of the present invention is illustrated in FIGS. 4-6. Like the first embodiment, this version comprises an enclosure 41 and a collar 42. Both the enclosure 41 and the collar 42 have an annular flange that extends substantially perpendicularly from the sidewall of the enclosure. The flange on the enclosure is referred to herein as an enclosure bezel 51 and the flange on the collar is referred to as the collar bezel 52. However, in the second embodiment, the interior sidewall of the enclosure 41 is threaded and the exterior of the collar 12 is constructed with threads to match. FIG. 4 shows an exploded view of the assembly, including a speaker 14 and a decorative speaker grille 15, aligned about the center axis.

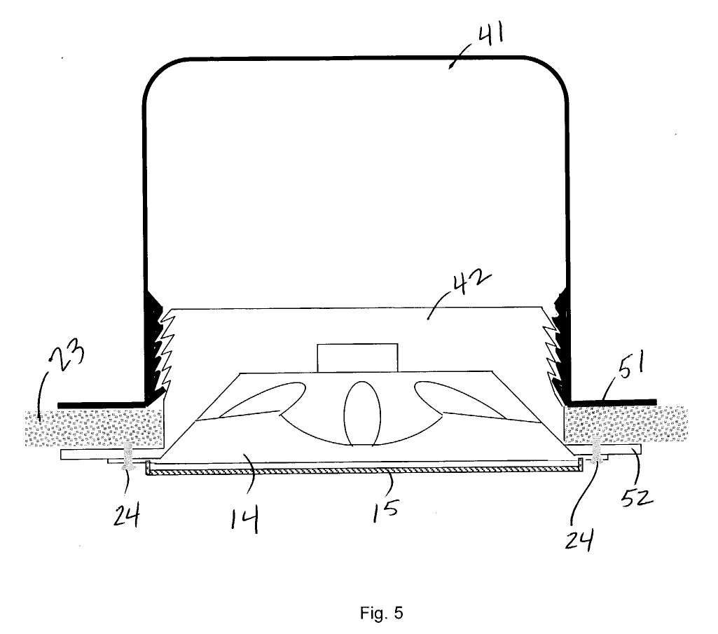

To install the assembly, one ceiling tile is removed from a drop ceiling. An aperture is cut into the ceiling tile in sufficient size and shape to accommodate the desired fixture. In the preferred embodiment, a speaker enclosure is used that is open on the bezel end and enclosed at the other end, with length between the bezel end and enclosed end to form a tubular cavity. In this second embodiment, the bezel 51 of the enclosure is placed against the back side of the ceiling tile 23, and the collar 42 is inserted from the front of the ceiling tile and screwed onto the enclosure until the ceiling tile 23 is securely sandwiched between the enclosure bezel 51 and the collar bezel 52. A speaker 14 is inserted into the enclosure from the front of the ceiling tile, so that the speaker diaphragm faces the room. The speaker 14 is attached to the collar with speaker screws 24 or other mounting means. Again, alternatively the speaker 14 may be attached to the collar with a friction fit, such as snap-fit or with threads. A grille 15 may be attached to the assembly over the speaker 14. FIG. 5 illustrates a cross-section of the assembled preferred second embodiment.

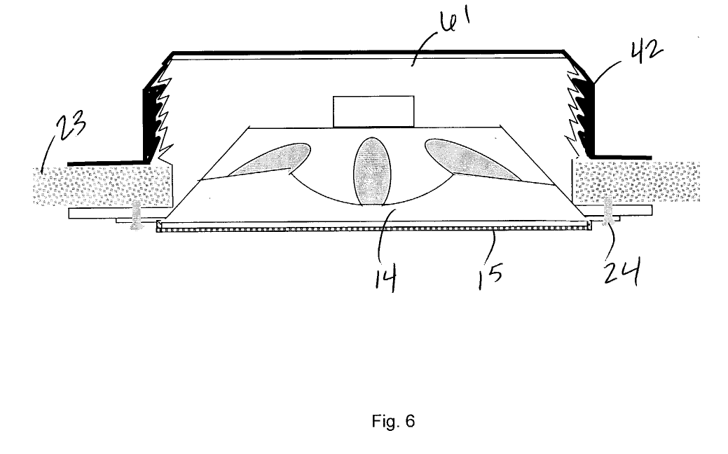

FIG. 6 illustrates a truncated enclosure 61 that is cropped short and open at both ends. Again, because the collar 42 is normally open at both ends, it will fit the standard enclosure 41 and the truncated enclosure 61 of the second embodiment.

If an acoustic device is installed in the assembly, the enclosure may be customized to effect the sound emitted. For example, the enclosure may have one or more apertures, or have a shape other than a tube, such as a cone- or dome-shaped end. Further, it may be fitted with baffles, sound-absorbing or sound-reflecting material, depending on the effect desired.

If a lighting device is installed in the assembly, the enclosure may be customized to effect the heat and light emitted. For example, the enclosure may have one or more apertures, or have a shape other than a tube, such as a cone- or dome shaped end. Further, it may be fitted with insulating material to prevent heat from radiating into the ceiling cavity. Optionally, a lens or other means for directing the light may be installed in place of the speaker grille.

For increased convenience, it may be desirable to pre-assemble the enclosure, speaker, and grille (or collar, speaker, and grille for the second embodiment).

Finally, while it is contemplated that the preferred embodiment of the device will be installed in ceiling tiles, it can be installed in other substrates as well. For example, the device can be installed in plaster, plywood and drywall, as long a cavity into which the fixture is recessed is accessible. The application to drywall lends itself to fixtures being installed in walls and floors.

While there has been illustrated and described what is at present considered to be the preferred embodiment of the present invention, it will be understood by those skilled in the art that various changes and modifications may be made and equivalents may be substituted for elements thereof without departing from the true scope of the invention. Therefore, it is intended that this invention not be limited to the particular embodiment disclosed, but that the invention will include all embodiments falling within the scope of the appended claims.

I claim:

1. An assembly for mounting a fixture in a substrate that has a front and a back, the assembly comprising:
a) an enclosure having a threaded sidewall; and
b) a collar that attaches to the sidewall with mated threads.

2. An assembly for mounting a fixture in a substrate that has a front and a back, the assembly comprising:
a) an enclosure having a threaded exterior sidewall and a bezel; and
b) a matedly-threaded collar;
wherein the enclosure is inserted from the front through an aperture in the substrate, the collar is placed over the enclosure from the back of the substrate and screwed onto the sidewall, thereby sandwiching the substrate between the collar and the bezel.

3. The assembly according to claim 2 wherein the collar further comprises a collar bezel.

4. The assembly according to claim 3 wherein the enclosure has one or more apertures.

5. The assembly according to claim 2 wherein the fixture is a speaker that is attached to the enclosure.

6. The assembly according to claim 5 further comprising a grille that is mounted over the front of the speaker.

7. The assembly according to claim 2 further wherein the fixture is a light socket.

8. The assembly according to claim 2 wherein the substrate is a ceiling tile.

9. An assembly for mounting a fixture in a substrate that has a front and a back, the assembly comprising:
a) an enclosure having a threaded interior sidewall and a bezel; and
b) a matedly-threaded collar;
wherein the enclosure is placed against the back of the substrate over an aperture, the collar is screwed onto the sidewall from the front of the substrate, thereby sandwiching the substrate between the collar and the bezel.

10. The assembly according to claim 9 wherein the collar further comprises a collar bezel.

11. The assembly according to claim 10 wherein the enclosure has apertures.

12. The assembly according to claim 9 wherein the fixture is a speaker that is attached to the collar.

13. The assembly according to claim 12 further comprising a grille that is mounted over the front of the speaker.

14. The assembly according to claim 9 further wherein the fixture is a light socket.

15. The assembly according to claim 9 wherein the substrate is a ceiling tile.

16. A method for installing an enclosure in a substrate having a front and back, the method comprising:
a) making an aperture in the substrate for receiving an enclosure having a bezel and a threaded sidewall;
b) inserting the enclosure into the aperture from the front of the substrate;
c) placing a matedly-threaded collar onto the enclosure from the back of the substrate and attaching the collar to the enclosure by screwing the collar to the bezel, thereby sandwiching the substrate between the collar and the bezel.

17. A method for installing an enclosure in a substrate having a front and back, the method comprising:
a) making an aperture in the substrate for receiving an enclosure having a bezel and a threaded sidewall;
b) placing the enclosure over the aperture from the back of the substrate;
c) attaching a matedly-threaded collar onto the enclosure from the front of the substrate by screwing the collar to the bezel, thereby sandwiching the substrate between the collar and the bezel.
